(19) United States
(12) Patent Application Publication
(10) Pub. No.: US 2025/0383805 A1
(43) Pub. Date: Dec. 18, 2025

(54) DIVIDING SUPERBLOCKS IN A MEMORY SYSTEM

(71) Applicant: Micron Technology, Inc., Boise, ID (US)

(72) Inventors: Paul Henry Chandler Smith, Boise, ID (US); Dionisio Minopoli, Frattamaggiore (NA) (IT); Giuseppe Cariello, Boise, ID (US)

(21) Appl. No.: 19/222,891

(22) Filed: May 29, 2025

Related U.S. Application Data
(60) Provisional application No. 63/659,230, filed on Jun. 12, 2024.

(51) Int. Cl. G06F 3/06

(52) U.S. Cl. CPC G06F 3/064; G06F 3/0604; G06F 3/0679

(57) ABSTRACT

Methods, systems, and devices for dividing superblocks in a memory system are described. A memory system may be configured to determine whether a first superblock includes a first quantity of valid physical blocks below a threshold to use the first superblock as an incomplete superblock. In response to determining that the first quantity of valid physical blocks is below the threshold, the memory system may generate a second superblock using one or more first valid physical blocks of the first superblock. In such cases, the memory system may access the second superblock based on generating the second superblock.

### CROSS REFERENCE

The present application for patent claims priority to U.S. Patent Application No. 63/659,230 by Smith et al., entitled “DIVIDING SUPERBLOCKS IN A MEMORY SYSTEM,” filed Jun. 12, 2024, which is assigned to the assignee hereof, and which is expressly incorporated by reference in its entirety herein.

### TECHNICAL FIELD

The following relates to one or more systems for memory, including dividing superblocks in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports dividing superblocks in a memory system in accordance with examples as disclosed herein.

FIG. 2 shows an example of a block diagram that supports dividing superblocks in a memory system in accordance with examples as disclosed herein.

FIG. 3 shows an example of block diagrams that supports dividing superblocks in a memory system in accordance with examples as disclosed herein.

FIG. 4 shows an example of a process flow that supports dividing superblocks in a memory system in accordance with examples as disclosed herein.

FIG. 5 shows a block diagram of a memory system that supports dividing superblocks in a memory system in accordance with examples as disclosed herein.

FIG. 6 shows a flowchart illustrating a method or methods that support dividing superblocks in a memory system in accordance with examples as disclosed herein.

### DETAILED DESCRIPTION

A memory system may support the use of superblocks, which include blocks (e.g., a set of blocks) from a contiguous set of planes (e.g., each plane) of the memory system. In some cases, the memory system may perform access operations on the blocks of the superblock. In some instances, however, the memory system may be unable to perform one or more access operations on the superblock if one or more blocks of the set of blocks associated with the superblock are invalid (e.g., bad, corrupt, otherwise inaccessible). In some such cases, the memory system may refrain from using the superblock if one or more blocks of the set of blocks associated with the superblock are invalid. However, by not using such superblocks (e.g., residue superblocks) it may decrease overprovisioning associated with the memory device, decrease the overall performance of the memory system, and the like. Accordingly, a memory system configured to divide such superblocks (e.g., residue superblocks) into usable, runt superblocks may be desirable.

In accordance with examples as described herein, a memory system may be configured to generate and access usable, runt superblocks from incomplete superblocks and/or residue superblocks. For example, the memory system may determine whether a superblock includes a quantity of valid physical blocks below a threshold to use the superblock as an incomplete superblock and/or residue superblock.

A memory system may have bad physical blocks that may disrupt parallelism that can be gained by using a complete superblock. To improve performance, a memory system may be configured replace bad blocks to create as many complete superblocks as possible. The memory system may, in some examples, scan one or more physical blocks to determine which physical blocks are valid and/or invalid. The memory system may then swap an invalid block in a first superblock with a valid block from second superblock, thereby making the first superblock a complete superblock. With this swapping of blocks, some superblocks will be left with a residue of valid blocks and may be unusable as a complete superblock or an incomplete superblock. Techniques are described to repurpose these residue blocks and form smaller superblocks that are usable in some contexts.

The memory system may perform such operations to create complete superblocks having no invalid blocks. Such operations may also result in some superblocks being incomplete superblocks (e.g., with one invalid block) or a residue superblock (with two or more invalid blocks). Accordingly, the methods described herein to divide incomplete superblocks and/or residue superblocks into usable, runt superblocks (e.g., able to be accessed) may increase overprovisioning associated with the memory system, which may improve performance and reduce costs. Moreover, dividing incomplete superblocks and/or residue superblocks into usable, runt superblocks may increase or otherwise prolong the usable storage capacity of the memory system, improve a total bytes writable to the memory system, among other advantages.

In addition to applicability in memory systems as described herein, techniques for dividing incomplete superblocks and/or residue superblocks of the memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by dividing incomplete superblocks and/or residue superblocks of the memory system, which may decrease processing or latency times, improve response times, or otherwise improve user experience, among other benefits.

Features of the disclosure are illustrated and described in the context of systems, devices, and circuits. Features of the disclosure are further illustrated and described in the context of block diagrams, a process, and flowcharts.

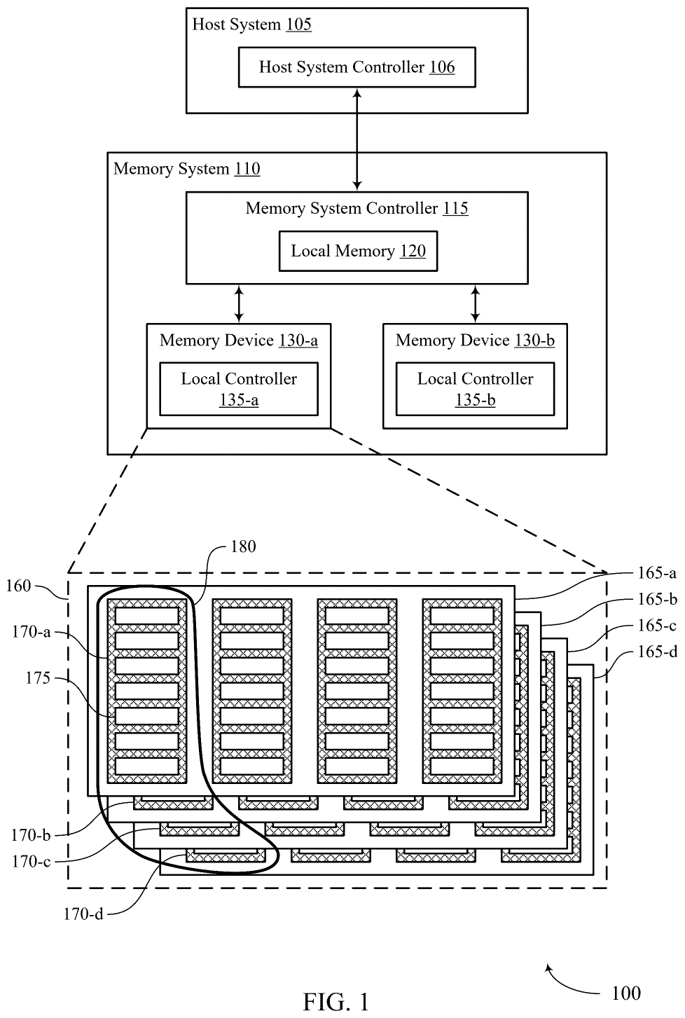

FIG. 1 shows an example of a system 100 that supports dividing superblocks in a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained, and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support dividing superblocks in a memory system. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

A complete superblock is a superblock that includes zero invalid block across a set of planes and/or dies. A runt superblock is a superblock that includes zero invalid blocks, but the size of the block is smaller than the complete superblock, and the runt superblock does not make use of the full set of planes. An incomplete superblock is a superblock that includes one or more invalid blocks, and a residue superblock is a superblock that includes two or more invalid blocks.

In accordance with examples as described herein, the memory system 110 may be configured to generate and access runt superblocks that do not include invalid blocks from incomplete superblocks (e.g., superblocks that include at least a singular invalid block) and may be configured to access available residue superblocks (e.g., superblocks that include two or more invalid blocks). For example, the memory system controller 115 may scan the physical blocks (e.g., of the memory device 130) associated with one or more superblocks to determine which physical blocks are valid. The memory system controller 115 may determine whether a superblock includes a quantity of valid physical blocks below a threshold to use the superblock as an incomplete superblock and/or a residue superblock. The memory system controller 115 may then generate a second superblock (e.g., a runt superblock) using the one or more valid physical blocks of the incomplete superblock and/or residue superblock. The memory system controller 115 may access the generated runt superblock that would otherwise be unusable (e.g., unable to be accessed) due to the presence of invalid physical blocks.

The memory system controller 115 may perform such operations to generate usable, runt superblocks from incomplete superblocks and/or residue superblocks. The generated runt superblocks may be accessible (e.g., by a host system), despite the incomplete superblock and/or residue superblock having at least one bad block. Accordingly, the methods described herein to divide incomplete and/or residue superblocks of the memory system into usable, runt superblocks may increase the overall performance of the memory system 110, improve the total bytes written to the memory system 110, and the like.

The system 100 may include any quantity of non-transitory computer readable media that support dividing superblocks in a memory system. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

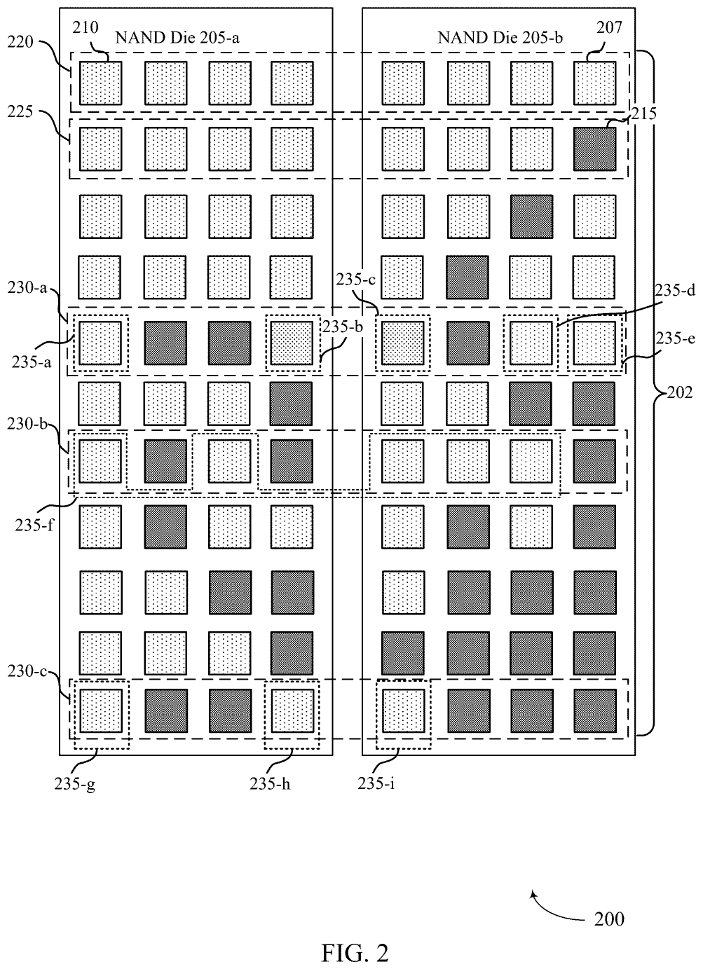

FIG. 2 shows an example of a block diagram 200 that supports dividing superblocks in a memory system in accordance with examples as disclosed herein. The block diagram 200 may illustrate aspects or operations of a system 100, as described with reference to FIG. 1. For example, operations illustrated by the block diagram 200 may be performed by a memory system 110 (e.g., a memory system controller 115) or a host system 105. The steps performed by the memory system may be implemented in instructions stored on memory of memory system 110 (e.g., memory device 130) and executed by the memory system controller 115 (and/or local controller 135). The steps performed by the host system may be implemented in instructions stored on memory of host system 105 and executed by the host system controller 106.

The block diagram 200 may depict dividing an incomplete superblock 225 and/or residue superblock 230 of the memory system into a usable, runt superblock 235. Such methods may increase the overall performance of the memory system. Moreover, accessing a runt superblock 235 that may otherwise be unused may increase or otherwise prolong the usable storage capacity of the memory system.

As described herein, each superblock 202 may include a set of blocks 207, which may be examples of a block 170, as described with reference to FIG. 1. Each superblock 202 may be associated with a set of physical blocks of the memory system from each plane of the memory system (e.g., 1 block from each plane) and may represent a logical (e.g., virtual) partitioning (e.g., grouping) of the set of physical blocks. Each superblock 202 may be an example of a virtual block 180 with a quantity of blocks 207 corresponding to a quantity of planes of the memory system, as described with reference to FIG. 1.

For example, each superblock 202 may include 8 blocks 207 (e.g., corresponding to 8 planes of the memory system), where each block 207 is associated with a plane of a memory system. A superblock may be logical construct to describe a set of blocks that are accessible in parallel. As defined herein, a superblock may define blocks that are each in different planes of different memory dies. In some cases, the memory system may include multiple memory devices such that each superblock 202 may include blocks 207 from each plane of the one or more memory devices. In some implementations, the blocks 207 may be ordered within a respective superblock 202 based on an order of the planes of the memory system, such that contiguous blocks 207 may be associated with continuous planes (e.g., a first block may correspond to a first plane, a second block may correspond to a second plane, etc.). Each superblock 202 may span more than one NAND die 205. For example, 4 blocks 207 may be included in a first NAND die 205-a and 4 blocks 207 may be included in a second NAND die 205-a. Eventually, superblocks may be categorized based on how many valid blocks the superblock includes (e.g., complete superblock 220, incomplete superblock 225, residue superblock 230, runt superblock 235).

A complete superblock 220 is a superblock that includes zero invalid blocks 215 across a set of planes and/or dies. A runt superblock 235 is a superblock that includes zero invalid blocks 215, but the size of the block is smaller than the complete superblock 220, and the runt superblock 235 does not make use of the full set of planes. An incomplete superblock 225 is a superblock that includes one or more invalid blocks 215, and a residue superblock 230 is a superblock that includes two or more invalid blocks 215.

In such cases, the superblocks 202 may include valid blocks 210 (e.g., a block including a quantity of valid data, a quantity of valid physical blocks, a quantity of operable access lines, or any combination thereof, that satisfies a threshold) and/or invalid blocks 215 (e.g., a quantity of invalid physical cells, a quantity of inoperable access lines, or any combination thereof, that satisfies a second threshold). In some cases, the invalid blocks 215 may be inaccessible while performing an access operation (e.g., a read operation, a write operation, a refresh operation, a media management operation, a wear leveling operation) or may otherwise result in one or more errors due to being accessed. In some instances, each superblock 202 may include a quantity of valid blocks 210, a quantity of invalid blocks 215, or both.

In some systems, the quantity of blocks per plane is no longer sufficient to allow an arrangement as shown with reference to block diagram 200 (e.g., two NAND dies 205 and four planes per NAND die 205 to include 8 blocks per superblock 202). Rather, the memory system may allow for a quantity of blocks to be sufficient, and the quantity of blocks per plane to be at least large enough to skip one block per superblock 202. In such cases, the memory system may enable smart die matching (SDM). In order to maintain consistent performance for the memory system, it may be desired that every superblock 202 is the same size (e.g., including a same quantity of blocks 207).

A memory system may have invalid blocks 215 that may disrupt parallelism that may be gained by using a complete superblock 220. The memory system may include one or more residue superblocks 230 that are not usable as incomplete superblocks 225 due to a quantity of valid blocks being below a threshold. With smaller quantities of valid blocks, the residue superblocks 230 have reduced parallelism, which may result in lower performance of the overall memory system. In such cases, it may be desired to assign valid blocks of the residue superblocks 230 to usable, runt superblocks 235 that enable the valid blocks 210 of the residue superblock 230 (e.g., incomplete superblock 225) to be accessed.

To improve performance, a memory system may be configured to swap invalid blocks 215 with valid blocks 210 to create as many complete superblocks 220 as possible. The process of creating complete superblocks 220 may result in some superblocks including a higher quantity of invalid blocks 215. In effect, a valid block 210 is moved from a first superblock to a second superblock and an invalid block 215 is moved from the second superblock to the first superblock. The result of this swapping is that the second superblock is more complete than it was before (and may even become a complete superblock 220) and the first superblock includes more invalid blocks and will likely be a residue superblock 230. By concentrating invalid blocks 215 in a few superblocks with this swapping scheme it may increase a percentage of superblocks that are complete superblocks 220 or incomplete superblocks 225. The memory system may, in some examples, scan one or more blocks 207 to determine which blocks are valid blocks 210 and/or invalid blocks 215. The memory system may then swap an invalid block 215 in a first superblock with a valid block 210 from second superblock, thereby making the first superblock a complete superblock 220 and making the second superblock an incomplete superblock 225 and/or a residue superblock 230. With this swapping of blocks 207, some superblocks 202 may be left with a residue of valid blocks 210 and may be unusable as a complete superblock 220 or an incomplete superblock 225.

In response to scanning the superblocks 202 and swapping the blocks 207, the memory system may determine that the residue superblock 230 includes a quantity of valid blocks 210 that is below a threshold. The threshold may be an example of a quantity of valid blocks 210 that is divisible by the quantity of planes. For example, the threshold may be 4 valid blocks 210. In some cases, the memory system may also identify the superblock (e.g., complete superblock 220, incomplete superblock 225, and/or residue superblock 230) in response to scanning the memory device. After identifying the superblock 202 with one or more invalid blocks 215 in the identified planes, the memory system may replace the one or more invalid blocks 215 with the one or more valid blocks 210 to generate as many complete superblocks 220 as possible.

For example, the memory system may determine that a first superblock includes an invalid block 215 in the third plane, and the memory system may replace the invalid block 215 in the first superblock with a valid block 210 from a third plane of a second superblock to generate the complete superblock 220. In such cases, the memory system may assign a physical block (e.g., the valid block 210) of the second superblock to the first superblock to generate the complete superblock 220, and assign a physical block (e.g., invalid block 215) of the first superblock to the second superblock to generate a residue superblock 230.

In some cases, adding the one or more invalid blocks 215 to the residue superblock 230 to make other superblocks 202 complete superblocks 220 may include updating a mapping of the complete superblock 220 and residue superblock 230, such that the one or more invalid blocks 215 are mapped to the residue superblock 230 and the one or more valid blocks 210 are mapped to the complete superblock 220. For example, the valid block 210 may be mapped to the complete superblock 220, and the invalid block 215 may be mapped to the residue superblock 230. In some implementations, updating the mapping may include updating a L2P table of the memory system (e.g., at non-volatile memory of the memory system), or a portion of the L2P table stored in volatile memory of the memory system. In some examples, access commands (e.g., read commands or write commands) may include one or more logical addresses that is mapped to one or more physical addresses using the L2P table. In some cases, the L2P table may associate physical blocks (whether valid or invalid) with various logical blocks (e.g., virtual blocks, superblocks).

In some cases, updating the mapping may include updating a bad block table to indicate that the invalid block 215 is assigned to the residue superblock 230 and/or the incomplete superblock 225 and to indicate that the invalid block 215 is further assigned to be the runt superblock 235. In some cases, updating the mapping may include updating a second data structure to indicate physical blocks assigned to superblocks 202 that include the quantity of valid blocks 210 below the threshold.

Techniques are described to repurpose these residue superblocks 230 and form smaller superblocks (e.g., runt superblocks 235) that are usable in some contexts. After identifying that the residue superblock 230 includes a quantity of valid blocks 210 that are below a threshold, the memory system may generate one or more runt superblocks 235 from the residue superblock 230. In such cases, the memory system may utilize valid blocks 210 to replace one or more invalid blocks 215 in the superblocks 202 to generate as many complete superblocks 220 as possible while also generating residue superblock 230 with the swapped invalid blocks 215, thereby enabling runt superblocks 235 to be generated from the residue superblocks 230.

For example, after the swapping of blocks 207 is complete, a first superblock may include 8 valid blocks 210 and may be an example of a complete superblock 220. A complete superblock 220 is a superblock may not include any invalid blocks 215 (e.g., includes zero invalid block 215 across a set of planes and/or dies). A second superblock may include 7 valid blocks 210 and 1 invalid block 215 in a fourth plane of the second NAND die 205-b, respectively, and may be an example of an incomplete superblock 225. An incomplete superblock 225 may include at least one invalid block 215. A third superblock may include 3 valid blocks 210 and 5 invalid blocks 215 in a second plane of the first NAND die 205-a, a third plane of the first NAND die 205-a, a second plane of the second NAND die 205-b, a third plane of the second NAND die 205-b, and a fourth place of the second NAND die 205-b, respectively. The third superblock may be an example of a residue superblock 230. A residue superblock 230 may include two or more invalid blocks 215. In some cases, the residue superblock 230 may include a quantity of valid blocks 210 that is not divisible by the quantity (e.g., number) of planes. The residue superblock 230 may be divided up into runt superblocks 235. A runt superblock 235 may include a quantity of valid blocks 210 that are less than a quantity of valid blocks 210 in the complete superblock 220 and less than a quantity of valid blocks 210 in the incomplete superblock 225. A runt superblock 235 is addressable for use by the memory system. The runt superblock 235 is a superblock that includes zero invalid blocks, and the size of the block is smaller than the complete superblock 220, The runt superblock 235 does not extend across the set of planes.

The memory system (e.g., or the host system) may generate the runt superblock 235 by identifying at least a residue superblock 230 having two or more invalid blocks 215 and determining that a quantity of valid blocks 210 are below a threshold and/or determining that the quantity of invalid blocks are above a threshold. The runt superblock 235 is independently addressable and may be accessed and used by the host system. While the runt superblock 235 may not be capable of the parallelism possible with a complete superblock 220, the runt superblock 235 may be useful in applications with smaller data sets where parallelism is not as useful for peak performance.

For example, the memory system may determine that the residue superblock 230-a may include 3 invalid blocks 215 and 5 valid blocks 210. In such cases, the residue superblock 230-a may be divided up into a first runt superblock 235-a, a second runt superblock 235-b, a third runt superblock 235-c, a fourth runt superblock 235-d, and a fifth runt superblock 235-e (e.g., each including a single valid block 210). The memory system may determine that residue superblock 230-b may include 3 invalid blocks 215 and 5 valid blocks 210. In such cases, the residue superblock 230-b may be divided up into a single runt superblock 235-f (e.g., including the 5 valid blocks 210). The memory system may determine that residue superblock 230-c may include 3 valid blocks 210 and 5 invalid blocks 215. In such cases, the residue superblock 230-c may be divided up into a first runt superblock 235-g, a second runt superblock 235-h, a third runt superblock 235-i (e.g., each including a single valid block 210).

The runt superblock 235 may be useful in applications with smaller data sets where parallelism is not as useful for peak performance. For example, the runt superblock 235 may be part of a replay protected memory block (RPMB) region of the memory system. In some cases, the runt superblock 235 may store information as SLCs, thereby using SLC programming. The runt superblocks 235 may each include a quantity of valid blocks 210 that are less than a quantity of valid blocks 210 of the complete superblock 220 and less than a quantity of valid blocks 210 of the incomplete superblock 225. In some cases, the runt superblock 235 may store information as MLCs, TLCs, QLCs, or a combination thereof.

In some implementations, the memory system may use a separate cursor to write the runt superblocks 235. For example, the memory system may generate a pool of superblocks and a cursor for the runt superblocks 235 and other superblocks that include the quantity of valid blocks 210 below the threshold. In such cases, the pool of superblocks may be expanded to include blocks from one or more incomplete superblocks 225. The memory system may use the cursor if the quantity of data written to the region of the memory device is large enough to justify the use of residue superblocks 230.

The cursor may be associated with locations (e.g., addresses) where information written may be stored. For example, the memory system may store (e.g., write) information written to one or more logical addresses at one or more physical addresses of a cursor. In some examples, a cursor may include one or more blocks of the memory system, such as one or more blocks or virtual blocks. In some examples, a cursor may be used to store a single type of information (e.g., all information written to the cursor may be of the same type). In some other examples, a cursor may store multiple types of information. In some cases, a cursor may be associated with memory cells configured to operate in accordance with a particular storage density.

For example, the memory system may rotate the blocks 207 of the residue superblock 230 with blocks in the main pool. Blocks in the main pool may wear-out faster than blocks in a residue superblock 230 or blocks in a runt superblock 235. Thus, by swapping valid blocks 210 from a complete superblock 220 with valid blocks 210 in a residue superblock 230 and/or a runt superblock 235, the life of the memory system may be extended. In such cases, the runt superblocks 235 may include a single block, as show in block diagram 200. The write cursor for runt superblocks 235 may be as wide as a quantity of valid blocks within the runt superblock 235. In some cases, rotating the blocks of the residue superblock 230 with blocks in the main pool may be performed stochastically. In such cases, the memory system may perform wear leveling, and a byte write rate to the runt superblock 235 may be less than the superblock pool. The wear leveling may vary per plane of the NAND die 205.

To rotate the blocks of the residue superblock 230 with blocks in the main pool, the memory system may select or create an erased incomplete superblock 225 using a selection algorithm. The memory system may perform garbage collection on every runt superblock 235 into the blocks on the erased incomplete superblock on the same planes. The memory system may erase some or all the current residue superblocks 230. The memory system may then swap one or more erased valid blocks of the residue superblocks 230 with one or more erased valid blocks of the incomplete superblock 225 that are in the same plane by either updating a bad block table or updating a second data structure designed to track these swaps.

For example, the memory system may update the bad block table to indicate the one or more valid blocks 210 assigned to the runt superblock 235 after generating the runt superblock 235. In other examples, the memory system may update a mapping that indicates physical blocks assigned to superblocks that include the quantity of valid blocks 210 below the threshold after generating the runt superblock 235. The memory system may re-initialize the runt superblock cursor after updating the bad block table or the second data structure (e.g., the mapping).

The memory system may access (e.g., read, write, erase, refresh, wear level) the runt superblocks 235 in accordance with performing one or more access operations. The memory system may be unable to access the invalid blocks 215 in the residue superblock 230. Therefore, the memory system may generate the one or more runt superblocks 235 in order to access the valid blocks 210 within the residue superblock 230. In some cases, the memory system may record an indication of a plane associated with the invalid block 215 of the residue superblock 230, and the memory system may use the indication to generate the runt superblocks 235 and skip the planes including the invalid blocks 215 during an access operation. For example, the memory system may receive an access command for an address of the one or more valid blocks 210 of the runt superblocks 235, and the memory system may access the runt superblocks 235 in response to receiving the access command. The memory system may access the address in direct response to determining whether the address is associated with a valid block 210 of the runt superblock 235.

In accordance with examples as described herein, the memory system may support generating runt superblocks 235. By supporting accessing the incomplete superblocks 225 and/or the residue superblocks 230, the memory system may access superblocks 202 that may have otherwise been inaccessible. Such methods may increase overprovisioning associated with the memory system, which may improve performances. Moreover, accessing incomplete superblocks 225 and/or residue superblocks 230 may increase or otherwise prolong the lifetime of the memory system.

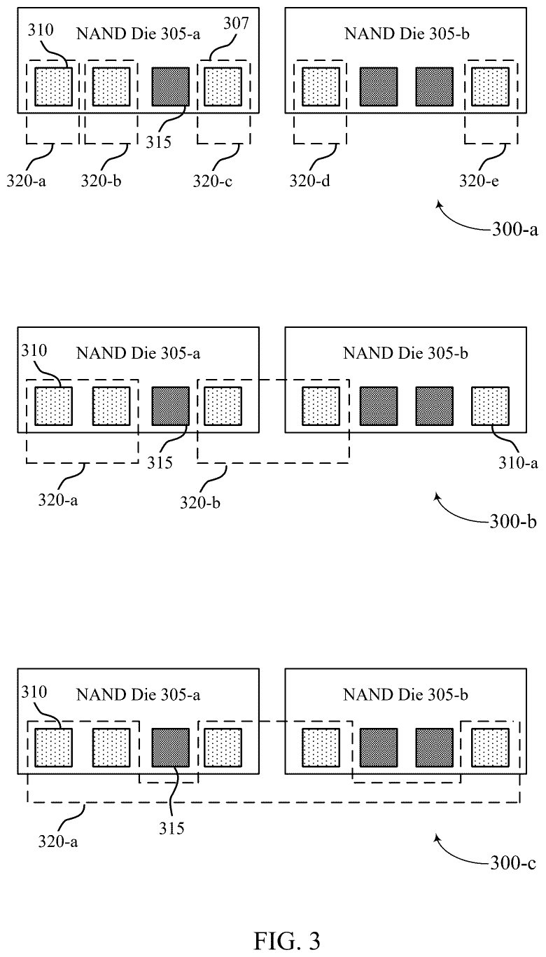

FIG. 3 shows an example of block diagrams 300 that supports dividing superblocks in a memory system in accordance with examples as disclosed herein. The block diagrams 300 may illustrate aspects or operations of a system 100 and block diagram 200, as described with reference to FIGS. 1 and 3. For example, operations illustrated by the block diagrams 300 may be performed by a memory system 110 (e.g., a memory system controller 115) or a host system 105. The steps performed by the memory system may be implemented in instructions stored on memory of memory system 110 (e.g., memory device 130) and executed by the memory system controller 115 (and/or local controller 135). The steps performed by the host system may be implemented in instructions stored on memory of host system 105 and executed by the host system controller 106. The block diagram 300 may depict dividing an incomplete and/or residue superblock of the memory system into runt superblocks 320.

As described with reference to FIG. 2, each NAND die 305 may include a set of blocks 307, which may be examples of a block 170, as described with reference to FIG. 1. Each NAND die 305 may be associated with a set of physical blocks of the memory system from each plane of the memory system (e.g., 1 block from each plane) and may represent a logical (e.g., virtual) partitioning (e.g., grouping) of the set of physical blocks.

In some cases, the blocks 307 may be valid blocks 310 (e.g., a block including a quantity of valid data, a quantity of valid physical blocks, a quantity of operable access lines, or any combination thereof, that satisfies a threshold) or invalid blocks 315 (e.g., a quantity of invalid physical cells, a quantity of inoperable access lines, or any combination thereof, that satisfies a second threshold). In some cases, the invalid blocks 315 may be inaccessible while performing an access operation (e.g., a read operation, a write operation, a refresh operation, a media management operation, a wear leveling operation) or may otherwise result in one or more errors due to being accessed. In some instances, each NAND die 305 may include a quantity of valid blocks 310, a quantity of invalid blocks 315, or both.

The block diagram 300-a depicts dividing an incomplete superblock and/or a residue superblock into a plurality of runt superblocks 320. For example, the memory system may generate a first runt superblock 320-a, a second runt superblock 320-b, a third runt superblock 320-c, and a fourth runt superblock 320-d, where each runt superblock 320 may include a single valid block 310. The memory system (e.g., or the host system) may generate a runt superblock 320 by identifying a superblock with a quantity of valid blocks 310 that is below a threshold, as described with reference to FIG. 2. The memory system may determine that block diagram 300-a may include five runt superblocks 320 each a single block wide. The memory system may access (e.g., read, write, erase, refresh, wear level) the runt superblocks 320 in accordance with performing one or more access operations, as described with reference to FIG. 2.

The block diagram 300-b depicts dividing an incomplete superblock and/or a residue superblock into a plurality of runt superblocks 320. For example, the memory system may generate a first runt superblock 320-a and a second runt superblock 320-b, where the runt superblocks 320 may each include more than one valid block 310. In such cases, each runt superblock 320 may include two valid blocks 310. The memory system (e.g., or the host system) may identify a residue superblock by identifying a superblock with a quantity of valid blocks 310 that is below a threshold. The memory system (e.g., or the host system) may generate runt superblocks 320 by assigning valid blocks 310 to a superblock number and placing the superblock number in a separate pool to be used by the host system.

In some cases, the memory system may identify a request to generate runt superblocks 320 that include more than one valid block 310 in each runt superblock 320. In such cases, the block diagram 300-b may include two runt superblocks 320 each two blocks wide (e.g., including two valid blocks 310), 3 invalid blocks 315, and one valid block 310 that is not part of a runt superblock 320. In such cases, the valid block 310-a may be a discarded and may be reassigned to the discard pool or may be used for other purposes as a single runt superblock that is one block in size. The memory system may access (e.g., read, write, erase, refresh, wear level) the runt superblocks 320 in accordance with performing one or more access operations, as described with reference to FIG. 2.

The block diagram 300-c depicts generating a runt superblock 320 by dividing an incomplete superblock into a single runt superblock 320. The runt superblock 320 may include more than one valid block 310. For example, the runt superblock 320 may include 5 valid blocks 310. The memory system (e.g., or the host system) may generate runt superblocks 320 by identifying a superblock with a quantity of valid blocks 310 that is below a threshold, as described with reference to FIG. 2.

The block diagram 300-c may include a single runt superblock 320 including 5 valid blocks 310 and 3 invalid blocks 315. As described with reference to FIG. 2, the memory system may generate the runt superblock 320 of block diagram 300-c and rotate blocks into and out of the main pool. For example, to rotate the blocks of the incomplete superblock with blocks in the main pool, the memory system may select or create an erased incomplete superblock. The memory system may perform garbage collection on the runt superblock 320 into the blocks on the erased incomplete superblock on the same planes. The memory system may erase all the current residue superblocks, and then the memory system may swap the erased residue superblocks with the blocks in the incomplete superblock that are in the same plane by either updating a bad block table or updating a second data structure designed to track these swaps.

The runt superblocks 320 may be used for non-time critical operations and/or low host queue depth operations. For example, the runt superblocks may be used for RPMB operations, small fragment cursor, a redundant array of independent NAND (RAIN) parity dump, a firmware logs, and the like. The runt superblocks 320 may be wear leveled and used in SLC Mode, to compensate with faster access time to account for the lower parallelism or to increase the obtainable total bytes writable to the memory system per runt superblock.

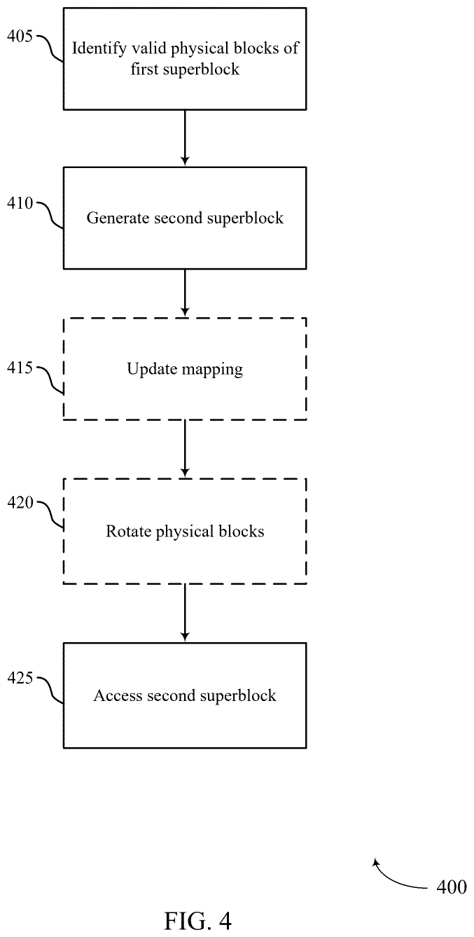

FIG. 4 shows an example of a process flow 400 that supports dividing superblocks in a memory system in accordance with examples as disclosed herein. The process flow 400 may illustrate aspects or operations of a system 100, block diagram 200, and block diagram 300, as described with reference to FIGS. 1 through 3, respectively. For example, the process flow 400 may depict operations for generating and access a second superblock, which may be examples of a runt superblock 235 and a runt superblock 320, as described with reference to FIGS. 2 and 3. Such methods may increase overprovisioning associated with the memory system, which is the extra physical size associated with logical size. Moreover, generating a second superblock may increase or otherwise prolong the lifetime of the memory system.

In the following description of the process flow 400, the methods, techniques, processes, and operations may be performed in different orders or at different times. Further, certain operations may be left out of the process flow 400, or other operations may be added to the process flow 400. The process flow 400 illustrates operations for generating a second superblock from an incomplete superblock as described with reference to FIGS. 2 and 3. The steps performed by the memory system may be implemented in instructions stored on memory of memory system 110 (e.g., memory device 130) and executed by the memory system controller 115 (and/or local controller 135).

Aspects of the process flow 400 may be implemented by one or more controllers, among other components. Additionally or alternatively, aspects of the process flow 400 may be implemented as instructions stored in one or more memories (e.g., firmware stored in one or more memories coupled with the memory system). For example, the instructions, when executed by one or more controllers (e.g., the memory system controller 115 and/or local controller 135), may cause the one or more controllers (or a device or a system) to perform the operations of the process flow 400.

At 405, valid physical blocks of a first superblock may be identified. For example, the memory system may determine whether the first superblock includes a first quantity of valid physical blocks below a threshold to use the first superblock as an incomplete superblock. The first superblock may be an example of superblocks 225 and 230, as described with reference to FIG. 2. In such cases, the memory system may identify that the first superblock is the incomplete superblock after determining that the first quantity of valid physical blocks is below the threshold.

In some cases, the memory system (e.g., or a host system coupled with the memory system) may scan superblocks of the memory system (e.g., memory device), which may be examples of superblocks 220, 225, and 230 as described with reference to FIG. 2. The memory system may scan the superblocks to determine and/or identify a quantity of invalid blocks and valid blocks in each superblock. In such cases, the memory system may determine that the first superblock includes the first quantity of valid physical blocks in response to scanning the superblocks.

In some examples, the memory system may identify a superblock with one or more invalid blocks, identify one or more planes corresponding to the one or more invalid blocks, or both. For example, the memory system may determine whether the first superblock includes a first quantity of invalid physical blocks above a threshold to use the first superblock as the incomplete superblock.

At 410, the second superblock (e.g., the usable, runt superblock) may be generated. For example, the memory system may generate the second superblock using one or more first valid physical blocks of the first superblock in response to determining that the first quantity of valid physical blocks is below the threshold. The second superblock may store information as a SLC (e.g., be used in SLC mode). The second superblock may be configured to store information associated with firmware logs, small fragment cursors, RAIN parity, replay protected memory blocks, or any combination thereof. In some cases, the second superblock may be part of the RPMB region of the memory system.

At 415, a mapping may be updated. For example, the memory system may update a bad block table to indicate the one or more first valid physical blocks assigned to the second superblock after generating the second superblock. In such cases, as part of using the second superblock, the memory system may update and use the bad block table. In some cases, the memory system may update a mapping that indicates physical blocks assigned to superblocks that include the first quantity of valid physical blocks below the threshold after generating the second superblock. In such cases, as part of using the second superblock, the memory system may update and use a second data structure (e.g., the mapping).

At 420, physical blocks may be rotated with a main pool of physical blocks. For example, the memory system may assign a first physical block of the second superblock to a complete superblock and assign a second physical block of the complete superblock to the second superblock. In such cases, the physical blocks of the second superblock may be rotated with physical blocks of a main pool (e.g., a complete superblock).

The memory system may determine whether a replacement pool (e.g., main pool) includes at least one valid block in at least one of the one or more identified planes. In some cases, the memory system may determine that the main pool includes at least one valid block in at least one of the one or more identified planes. The memory system may replace an invalid block of the second superblock with the valid block. In such cases, the memory system may replace the valid block of the main pool with the invalid block of the second superblock.

In response to rotating physical blocks with the main pool of physical blocks, the memory system may update a bad block table to indicate that the first physical block is assigned to the complete superblock and to indicate that the second physical block is assigned to the second superblock. In such cases, the memory system may update and use the bad block table as part of rotating physical blocks between the second superblock and the main pool (e.g., the complete superblock).

In some cases, the memory system may update a mapping to indicate that the first physical block is assigned to the complete superblock and to indicate that the second physical block is assigned to the second superblock. The mapping may indicate physical blocks assigned to superblocks that include the first quantity of valid physical blocks below the threshold. In such cases, the memory system may update and use the second data structure as part of rotating the physical blocks the second superblock and the main pool (e.g., the complete superblock).

At 425, the second superblock may be accessed. For example, the memory system may access the second superblock after generating the second superblock. The memory system may receive an access command after generating the second superblock. In such cases, the host system may transmit the access command, and the memory system may access the second superblock in response to receiving the access command. The memory system may access the second superblock after assigning the second physical block to the second superblock (e.g., after rotating physical blocks from the main pool into the second superblock). In some examples, the memory system may access the second superblock after (e.g., in response to) updating the bad block table, updating the mapping, or both.

In some cases, the memory system may use a separate second superblock pool and cursor to access the second superblock. For example, the memory system may generate a pool of blocks and a cursor for the second superblock and other superblocks that include the first quantity of valid physical blocks below the threshold. The pool of blocks may include incomplete superblocks and superblocks that include the first quantity of valid physical blocks below the threshold. In such cases, the second superblock pool may be expanded to include incomplete superblocks. Such methods may increase overprovisioning associated with the memory system and prolong the usable storage capacity of the memory system.

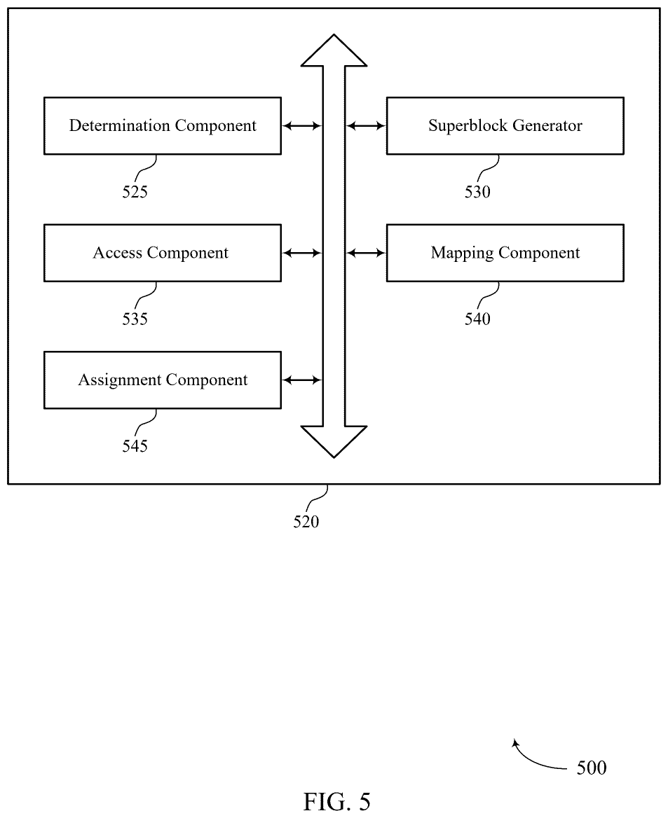

FIG. 5 shows a block diagram 500 of a memory system 520 that supports dividing superblocks in a memory system in accordance with examples as disclosed herein. The memory system 520 may be an example of aspects of a memory system as described with reference to FIGS. 1 through 4. The memory system 520, or various components thereof, may be an example of means for performing various aspects of dividing superblocks in a memory system as described herein. For example, the memory system 520 may include a determination component 525, a superblock generator 530, an access component 535, a mapping component 540, an assignment component 545, or any combination thereof. Each of these components, or components of subcomponents thereof (e.g., one or more processors, one or more memories), may communicate, directly or indirectly, with one another (e.g., via one or more buses).

The determination component 525 may be configured as or otherwise support a means for determining whether a first superblock includes a first quantity of valid physical blocks below a threshold to use the first superblock as an incomplete superblock. The superblock generator 530 may be configured as or otherwise support a means for generating a second superblock using one or more first valid physical blocks of the first superblock based at least in part on determining that the first quantity of valid physical blocks is below the threshold. The access component 535 may be configured as or otherwise support a means for accessing the second superblock based at least in part on generating the second superblock.

In some examples, the access component 535 may be configured as or otherwise support a means for generating a pool of blocks and a cursor for the second superblock and other superblocks that include the first quantity of valid physical blocks below the threshold, where accessing the second superblock is based at least in part on generating the pool.

In some examples, the pool of blocks includes incomplete superblocks and superblocks that include the first quantity of valid physical blocks below the threshold.

In some examples, the mapping component 540 may be configured as or otherwise support a means for updating a bad block table to indicate the one or more first valid physical blocks assigned to the second superblock after generating the second superblock, where accessing the second superblock is based at least in part on updating the bad block table.

In some examples, the mapping component 540 may be configured as or otherwise support a means for updating a mapping that indicates physical blocks assigned to superblocks that include the first quantity of valid physical blocks below the threshold after generating the second superblock, where accessing the second superblock is based at least in part on updating the mapping.

In some examples, the assignment component 545 may be configured as or otherwise support a means for assigning a first physical block of the second superblock to a complete superblock. In some examples, the assignment component 545 may be configured as or otherwise support a means for assigning a second physical block of the complete superblock to the second superblock. In some examples, the access component 535 may be configured as or otherwise support a means for accessing the second superblock after assigning the second physical block to the second superblock.

In some examples, the mapping component 540 may be configured as or otherwise support a means for updating a bad block table to indicate that the first physical block is assigned to the complete superblock and to indicate that the second physical block is assigned to the second superblock, where accessing the second superblock is based at least in part on updating the bad block table.

In some examples, the mapping component 540 may be configured as or otherwise support a means for updating a mapping to indicate that the first physical block is assigned to the complete superblock and to indicate that the second physical block is assigned to the second superblock, where the mapping indicates physical blocks assigned to superblocks that include the first quantity of valid physical blocks below the threshold, where accessing the second superblock is based at least in part on updating the mapping.

In some examples, the second superblock stores information as single-level cells.

In some examples, the second superblock is configured to store information associated with firmware logs, small fragment cursors, redundant array of independent NAND (RAIN) parity, replay protected memory blocks, or any combination thereof.

In some examples, the second superblock is part of a replay protected memory block (RPMB) region of the memory system.

In some examples, the superblock generator 530 may be configured as or otherwise support a means for generating a third superblock using one or more second valid physical blocks of the first superblock, where a second quantity of the valid physical blocks in the second superblock is different than a third quantity of the valid physical blocks in the third superblock.

In some examples, one of the second superblock or the third superblock includes a single physical block.

In some examples, the determination component 525 may be configured as or otherwise support a means for scanning a plurality of superblocks of a memory device to identify valid physical blocks and invalid physical blocks, where determining that the first superblock includes the first quantity of valid physical blocks is based at least in part on scanning the plurality of superblocks.

In some examples, the access component 535 may be configured as or otherwise support a means for receiving an access command based at least in part on generating the second superblock, where accessing the second superblock is based at least in part on receiving the access command.

In some examples, the first superblock includes the incomplete superblock based at least in part on determining that the first quantity of valid physical blocks is below the threshold.

In some examples, the second superblock includes a second quantity of valid physical blocks that is less than a third quantity of valid physical blocks of a complete superblock and less than a fourth quantity of valid physical blocks of the incomplete superblock.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

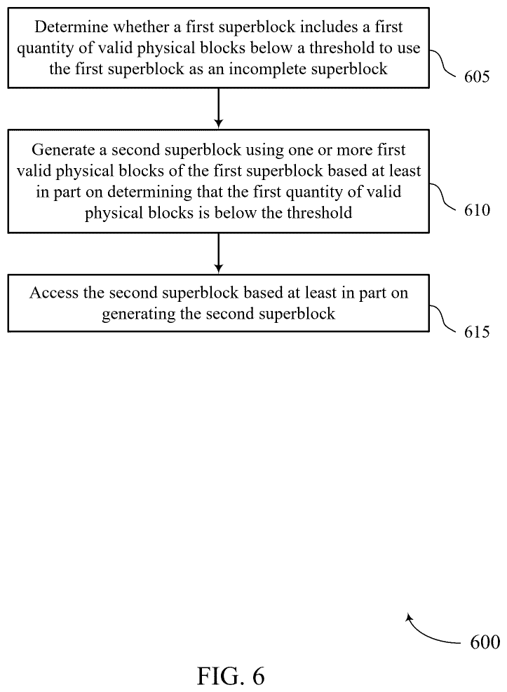

FIG. 6 shows a flowchart illustrating a method 600 that supports dividing superblocks in a memory system in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include determining whether a first superblock includes a first quantity of valid physical blocks below a threshold to use the first superblock as an incomplete superblock. In some examples, aspects of the operations of 605 may be performed by a determination component 525 as described with reference to FIG. 5.

At 610, the method may include generating a second superblock using one or more first valid physical blocks of the first superblock based at least in part on determining that the first quantity of valid physical blocks is below the threshold. In some examples, aspects of the operations of 610 may be performed by a superblock generator 530 as described with reference to FIG. 5.

At 615, the method may include accessing the second superblock based at least in part on generating the second superblock. In some examples, aspects of the operations of 615 may be performed by an access component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for determining whether a first superblock includes a first quantity of valid physical blocks below a threshold to use the first superblock as an incomplete superblock; generating a second superblock using one or more first valid physical blocks of the first superblock based at least in part on determining that the first quantity of valid physical blocks is below the threshold; and accessing the second superblock based at least in part on generating the second superblock.

Aspect 2: The method, apparatus, or non-transitory computer-readable medium of aspect 1, further including operations, features, circuitry, logic, means, or instructions, or any combination thereof for generating a pool of blocks and a cursor for the second superblock and other superblocks that include the first quantity of valid physical blocks below the threshold, where accessing the second superblock is based at least in part on generating the pool.

Aspect 3: The method, apparatus, or non-transitory computer-readable medium of aspect 2, where the pool of blocks includes incomplete superblocks and superblocks that include the first quantity of valid physical blocks below the threshold.

Aspect 4: The method, apparatus, or non-transitory computer-readable medium of any of aspects 1 through 3, further including operations, features, circuitry, logic, means, or instructions, or any combination thereof for updating a bad block table to indicate the one or more first valid physical blocks assigned to the second superblock after generating the second superblock, where accessing the second superblock is based at least in part on updating the bad block table.

Aspect 5: The method, apparatus, or non-transitory computer-readable medium of any of aspects 1 through 4, further including operations, features, circuitry, logic, means, or instructions, or any combination thereof for updating a mapping that indicates physical blocks assigned to superblocks that include the first quantity of valid physical blocks below the threshold after generating the second superblock, where accessing the second superblock is based at least in part on updating the mapping.

Aspect 6: The method, apparatus, or non-transitory computer-readable medium of any of aspects 1 through 5, further including operations, features, circuitry, logic, means, or instructions, or any combination thereof for assigning a first physical block of the second superblock to a complete superblock; assigning a second physical block of the complete superblock to the second superblock; and accessing the second superblock after assigning the second physical block to the second superblock.

Aspect 7: The method, apparatus, or non-transitory computer-readable medium of aspect 6, further including operations, features, circuitry, logic, means, or instructions, or any combination thereof for updating a bad block table to indicate that the first physical block is assigned to the complete superblock and to indicate that the second physical block is assigned to the second superblock, where accessing the second superblock is based at least in part on updating the bad block table.

Aspect 8: The method, apparatus, or non-transitory computer-readable medium of any of aspects 6 through 7, further including operations, features, circuitry, logic, means, or instructions, or any combination thereof for updating a mapping to indicate that the first physical block is assigned to the complete superblock and to indicate that the second physical block is assigned to the second superblock, where the mapping indicates physical blocks assigned to superblocks that include the first quantity of valid physical blocks below the threshold, where accessing the second superblock is based at least in part on updating the mapping.

Aspect 9: The method, apparatus, or non-transitory computer-readable medium of any of aspects 1 through 8, where the second superblock stores information as single-level cells.

Aspect 10: The method, apparatus, or non-transitory computer-readable medium of any of aspects 1 through 9, where the second superblock is configured to store information associated with firmware logs, small fragment cursors, redundant array of independent NAND (RAIN) parity, replay protected memory blocks, or any combination thereof.

Aspect 11: The method, apparatus, or non-transitory computer-readable medium of any of aspects 1 through 10, where the second superblock is part of a replay protected memory block (RPMB) region of the memory system.

Aspect 12: The method, apparatus, or non-transitory computer-readable medium of any of aspects 1 through 11, further including operations, features, circuitry, logic, means, or instructions, or any combination thereof for generating a third superblock using one or more second valid physical blocks of the first superblock, where a second quantity of the valid physical blocks in the second superblock is different than a third quantity of the valid physical blocks in the third superblock.

Aspect 13: The method, apparatus, or non-transitory computer-readable medium of aspect 12, where one of the second superblock or the third superblock includes a single physical block.

Aspect 14: The method, apparatus, or non-transitory computer-readable medium of any of aspects 1 through 13, further including operations, features, circuitry, logic, means, or instructions, or any combination thereof for scanning a plurality of superblocks of a memory device to identify valid physical blocks and invalid physical blocks, where determining that the first superblock includes the first quantity of valid physical blocks is based at least in part on scanning the plurality of superblocks.

Aspect 15: The method, apparatus, or non-transitory computer-readable medium of any of aspects 1 through 14, further including operations, features, circuitry, logic, means, or instructions, or any combination thereof for receiving an access command based at least in part on generating the second superblock, where accessing the second superblock is based at least in part on receiving the access command.

Aspect 16: The method, apparatus, or non-transitory computer-readable medium of any of aspects 1 through 15, where the first superblock includes the incomplete superblock based at least in part on determining that the first quantity of valid physical blocks is below the threshold.

Aspect 17: The method, apparatus, or non-transitory computer-readable medium of any of aspects 1 through 16, where the second superblock includes a second quantity of valid physical blocks that is less than a third quantity of valid physical blocks of a complete superblock and less than a fourth quantity of valid physical blocks of the incomplete superblock.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
determine whether a first superblock comprises a first quantity of valid physical blocks below a threshold to use the first superblock as an incomplete superblock;
generate a second superblock using one or more first valid physical blocks of the first superblock based at least in part on determining that the first quantity of valid physical blocks is below the threshold; and
access the second superblock based at least in part on generating the second superblock.

2. The memory system of claim 1, wherein the processing circuitry is further configured to cause the memory system to:
generate a pool of blocks and a cursor for the second superblock and other superblocks that include the first quantity of valid physical blocks below the threshold, wherein accessing the second superblock is based at least in part on generating the pool.

3. The memory system of claim 2, wherein the pool of blocks includes incomplete superblocks and superblocks that include the first quantity of valid physical blocks below the threshold.

4. The memory system of claim 1, wherein the processing circuitry is further configured to cause the memory system to:
update a bad block table to indicate the one or more first valid physical blocks assigned to the second superblock after generating the second superblock, wherein accessing the second superblock is based at least in part on updating the bad block table.

5. The memory system of claim 1, wherein the processing circuitry is further configured to cause the memory system to:
update a mapping that indicates physical blocks assigned to superblocks that include the first quantity of valid physical blocks below the threshold after generating the second superblock, wherein accessing the second superblock is based at least in part on updating the mapping.

6. The memory system of claim 1, wherein the processing circuitry is further configured to cause the memory system to:
assign a first physical block of the second superblock to a complete superblock;
assign a second physical block of the complete superblock to the second superblock; and
access the second superblock after assigning the second physical block to the second superblock.

7. The memory system of claim 6, wherein the processing circuitry is further configured to cause the memory system to:
update a bad block table to indicate that the first physical block is assigned to the complete superblock and to indicate that the second physical block is assigned to the second superblock, wherein accessing the second superblock is based at least in part on updating the bad block table.

8. The memory system of claim 6, wherein the processing circuitry is further configured to cause the memory system to:
update a mapping to indicate that the first physical block is assigned to the complete superblock and to indicate that the second physical block is assigned to the second superblock, wherein the mapping indicates physical blocks assigned to superblocks that include the first quantity of valid physical blocks below the threshold, wherein accessing the second superblock is based at least in part on updating the mapping.

9. The memory system of claim 1, wherein:
the second superblock stores information as single-level cells.

10. The memory system of claim 1, wherein the second superblock is configured to store information associated with firmware logs, small fragment cursors, redundant array of independent NAND (RAIN) parity, replay protected memory blocks, or any combination thereof.

11. The memory system of claim 1, wherein the second superblock is part of a replay protected memory block (RPMB) region of the memory system.

12. The memory system of claim 1, wherein the processing circuitry is further configured to cause the memory system to:
generate a third superblock using one or more second valid physical blocks of the first superblock, wherein a second quantity of the valid physical blocks in the second superblock is different than a third quantity of the valid physical blocks in the third superblock.

13. The memory system of claim 12, wherein one of the second superblock or the third superblock comprises a single physical block.

14. The memory system of claim 1, wherein the processing circuitry is further configured to cause the memory system to:
scan a plurality of superblocks of a memory device to identify valid physical blocks and invalid physical blocks, wherein determining that the first superblock comprises the first quantity of valid physical blocks is based at least in part on scanning the plurality of superblocks.

15. The memory system of claim 1, wherein the processing circuitry is further configured to cause the memory system to:
receive an access command based at least in part on generating the second superblock, wherein accessing the second superblock is based at least in part on receiving the access command.

16. The memory system of claim 1, wherein the first superblock comprises the incomplete superblock based at least in part on determining that the first quantity of valid physical blocks is below the threshold.

17. The memory system of claim 1, wherein the second superblock comprises a second quantity of valid physical blocks that is less than a third quantity of valid physical blocks of a complete superblock and less than a fourth quantity of valid physical blocks of the incomplete superblock.

18. A non-transitory computer-readable medium storing code comprising instructions which, when executed by processing circuitry of an electronic device, cause the electronic device to:
determine whether a first superblock comprises a first quantity of valid physical blocks below a threshold to use the first superblock as an incomplete superblock;
generate a second superblock using one or more first valid physical blocks of the first superblock based at least in part on determining that the first quantity of valid physical blocks is below the threshold; and
access the second superblock based at least in part on generating the second superblock.

19. The non-transitory computer-readable medium of claim 18, wherein the instructions are further executable by the processing circuitry to:
generate a pool of blocks and a cursor for the second superblock and other superblocks that include the first quantity of valid physical blocks below the threshold, wherein accessing the second superblock is based at least in part on generating the pool.

20. The non-transitory computer-readable medium of claim 19, wherein the pool of blocks includes incomplete superblocks and superblocks that include the first quantity of valid physical blocks below the threshold.

21. The non-transitory computer-readable medium of claim 18, wherein the instructions are further executable by the processing circuitry to:
update a bad block table to indicate the one or more first valid physical blocks assigned to the second superblock after generating the second superblock, wherein accessing the second superblock is based at least in part on updating the bad block table.

22. The non-transitory computer-readable medium of claim 18, wherein the instructions are further executable by the processing circuitry to:
update a mapping that indicates physical blocks assigned to superblocks that include the first quantity of valid physical blocks below the threshold after generating the second superblock, wherein accessing the second superblock is based at least in part on updating the mapping.

23. A method by a memory system, comprising:
determining whether a first superblock comprises a first quantity of valid physical blocks below a threshold to use the first superblock as an incomplete superblock;
generating a second superblock using one or more first valid physical blocks of the first superblock based at least in part on determining that the first quantity of valid physical blocks is below the threshold; and
accessing the second superblock based at least in part on generating the second superblock.

24. The method of claim 23, further comprising:
generating a pool of blocks and a cursor for the second superblock and other superblocks that include the first quantity of valid physical blocks below the threshold, wherein accessing the second superblock is based at least in part on generating the pool.

25. The method of claim 24, wherein the pool of blocks includes incomplete superblocks and superblocks that include the first quantity of valid physical blocks below the threshold.
